(19) United States
(12) Patent Application Publication
(10) Pub. No.: US 2025/0247317 A1
(43) Pub. Date: Jul. 31, 2025

(54) STATE-BASED OBSERVABILITY TRAFFIC SIMULATIONS

(71) Applicant: Cisco Technology, Inc., San Jose, CA (US)

(72) Inventors: Geoffrey R. HENDREY, San Anselmo, CA (US); Manpreet SINGH, Bengaluru (IN)

(21) Appl. No.: 18/425,167

(22) Filed: Jan. 29, 2024

(51) Int. Cl. H04L 43/50; H04L 43/028; H04L 43/04

(52) U.S. Cl. CPC H04L 43/50; H04L 43/028; H04L 43/04

(57) ABSTRACT

In one embodiment, a method includes generating a plurality of simulated resources based on a customized simulation configuration expression that defines one or more resource types and a respective number of each of the one or more resource types to generate. The method further includes determining, from the customized simulation configuration expression, observability metrics to be produced in relation to the plurality of simulated resources and a plurality of possible values for the observability metrics and executing a simulation with the plurality of simulated resources to produce simulated observability metrics for the simulation.

### TECHNICAL FIELD

The present disclosure relates generally to computer systems, and, more particularly, to state-based observability traffic simulations.

### BACKGROUND

The Internet and the World Wide Web have enabled the proliferation of web services available for virtually all types of businesses. Due to the accompanying complexity of the infrastructure supporting the web services, it is becoming increasingly difficult to maintain the highest level of service performance and user experience to keep up with the increase in web services. For example, it can be challenging to piece together monitoring and logging data across disparate systems, tools, and layers in a network architecture. Moreover, even when data can be obtained, it is difficult to directly connect the chain of events and cause and effect.

In particular, when building or working with platforms built for analyzing application/infrastructure performance, there is an implicit need to test such a platform and demonstrate its capabilities. This need also extends to any solutions or other extensions that are built on top of the platform, as well. Increasingly, these monitoring platforms are using known network metric collection/observability standards, which define the message schema of the messages sent from the observed application/infrastructure to the monitoring platform for analysis.

Today, demonstrating the capabilities of the application/infrastructure is typically achieved by first deploying dummy infrastructure for observation. Of course, there is an extra resource cost associated with doing this for testing/demo purposes. In addition, such testing cannot be precisely controlled, and the actual data being sent to the platform is not deterministic.

Simulating network metric collection message traffic would open up new opportunities for purposes of testing and demos. However, this is not a simple task, particularly with respect to the experience of third parties building extensions on top of the platform. Indeed, they may be required to perform deeply involved, code-based setup and deployment of the solution. Debugging any input errors can also prove challenging, depending on the implementation.

### BRIEF DESCRIPTION OF THE DRA WINGS

The embodiments herein may be better understood by referring to the following description in conjunction with the accompanying drawings in which like reference numerals indicate identically or functionally similar elements, of which:

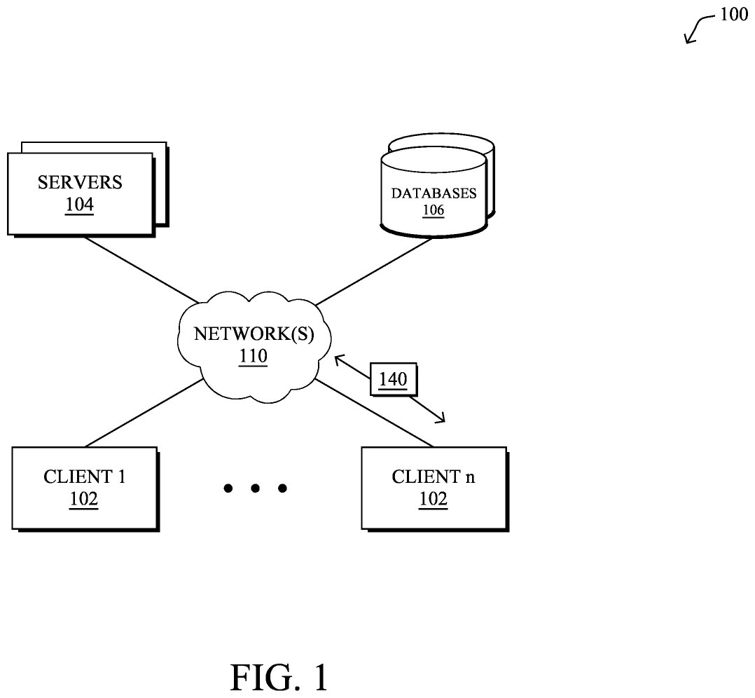

FIG. 1 illustrates an example computer network;

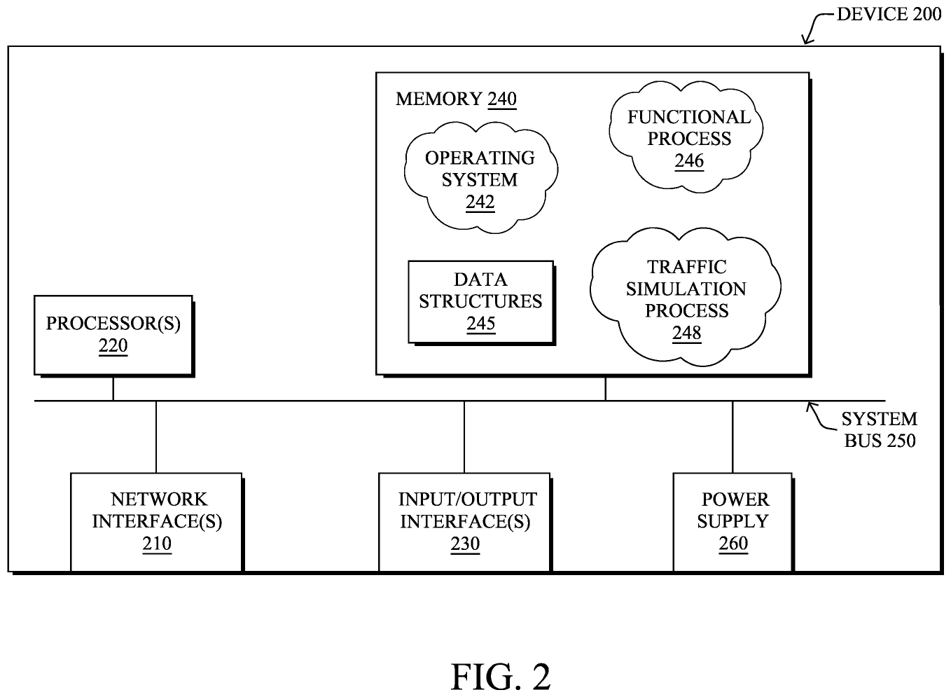

FIG. 2 illustrates an example computing device/node;

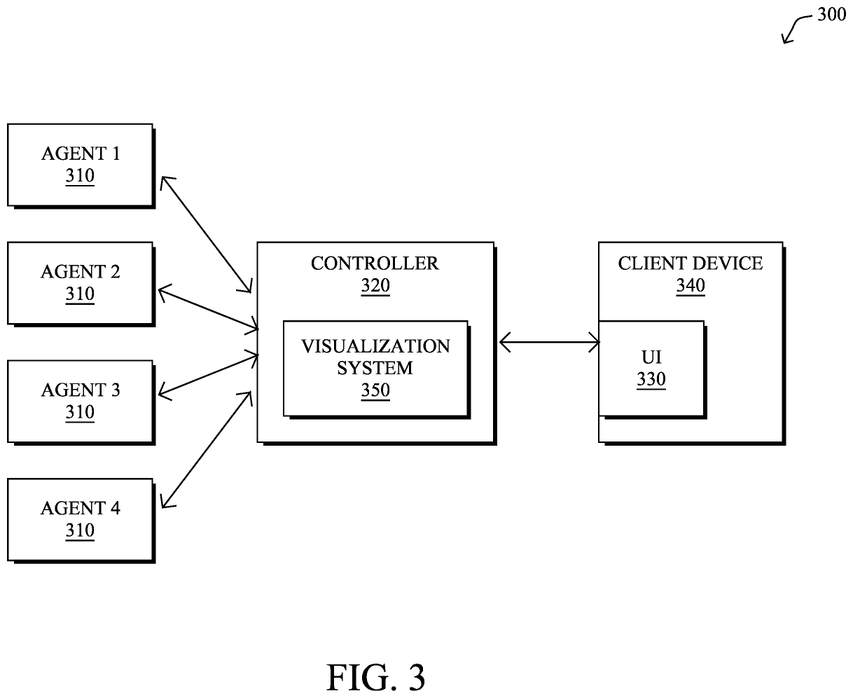

FIG. 3 illustrates an example observability intelligence platform;

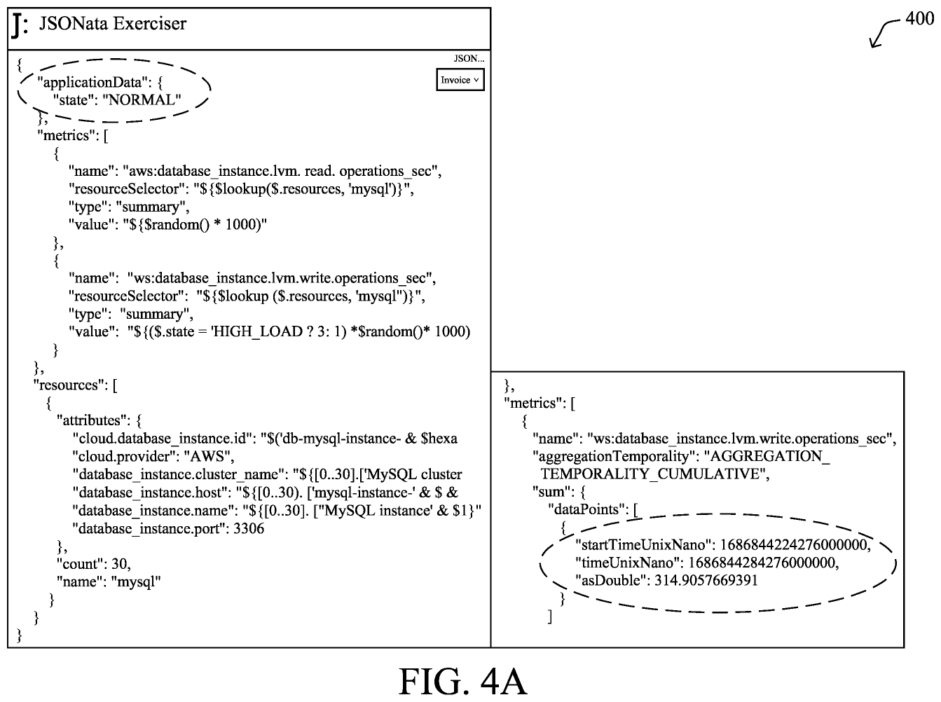

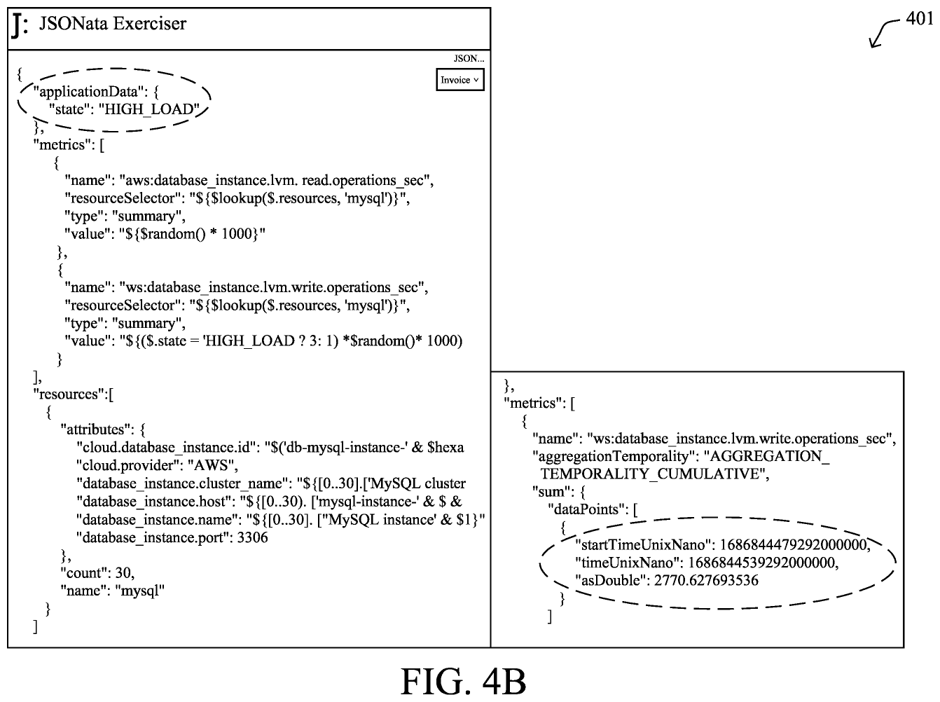

FIGS. 4A-4B illustrate an example change in a configuration expression based on a change in a state field in accordance with one or more embodiments described herein;

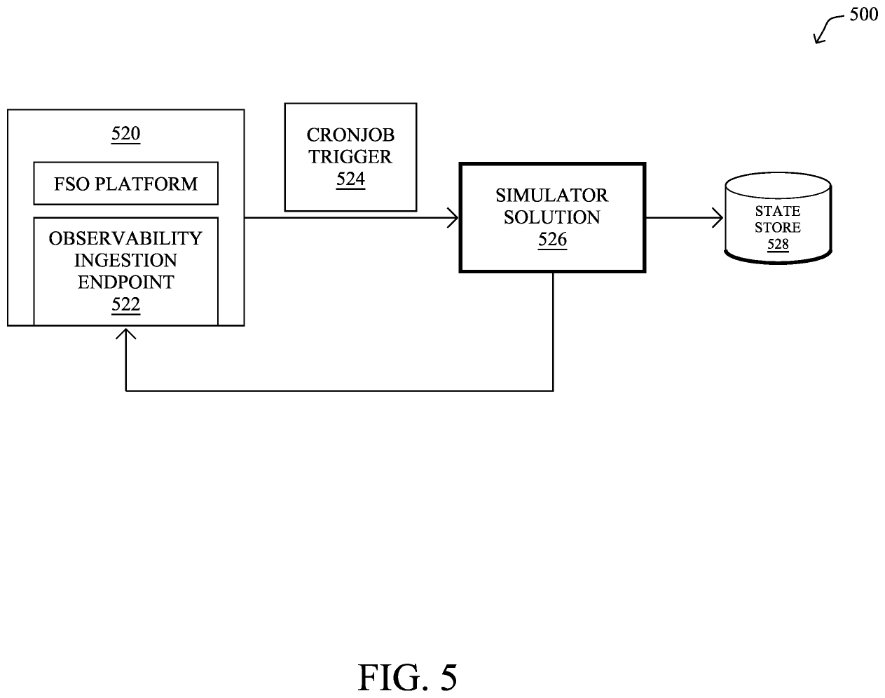

FIG. 5 illustrates an example platform for state-based network metric collection traffic simulations in accordance with one or more embodiments described herein;

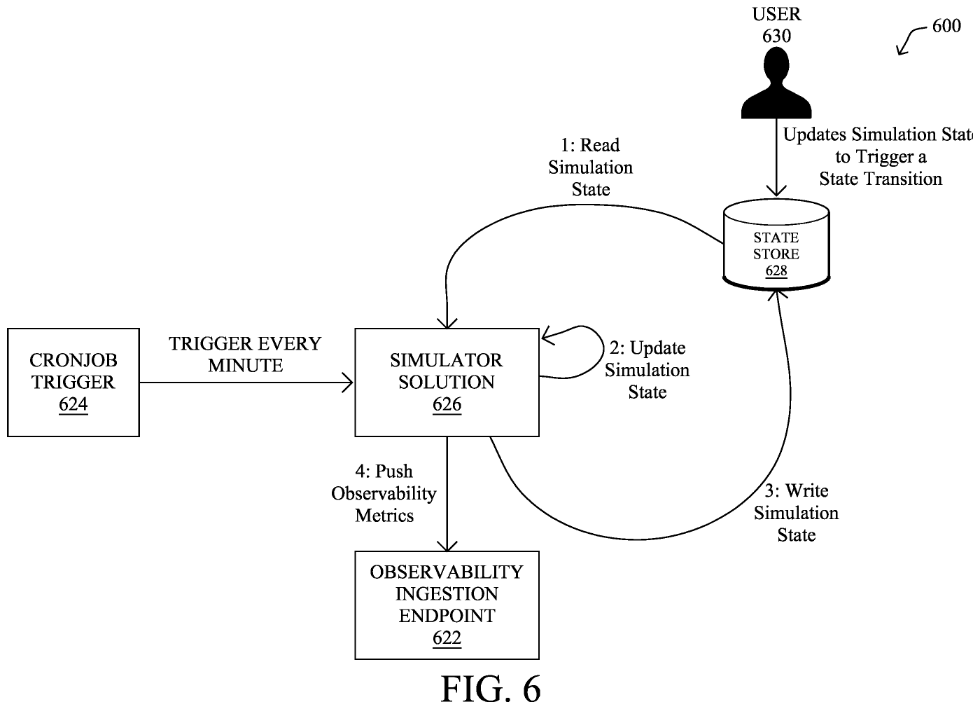

FIG. 6 illustrates an example state diagram for state-based observability traffic simulations in accordance with one or more embodiments described herein; and

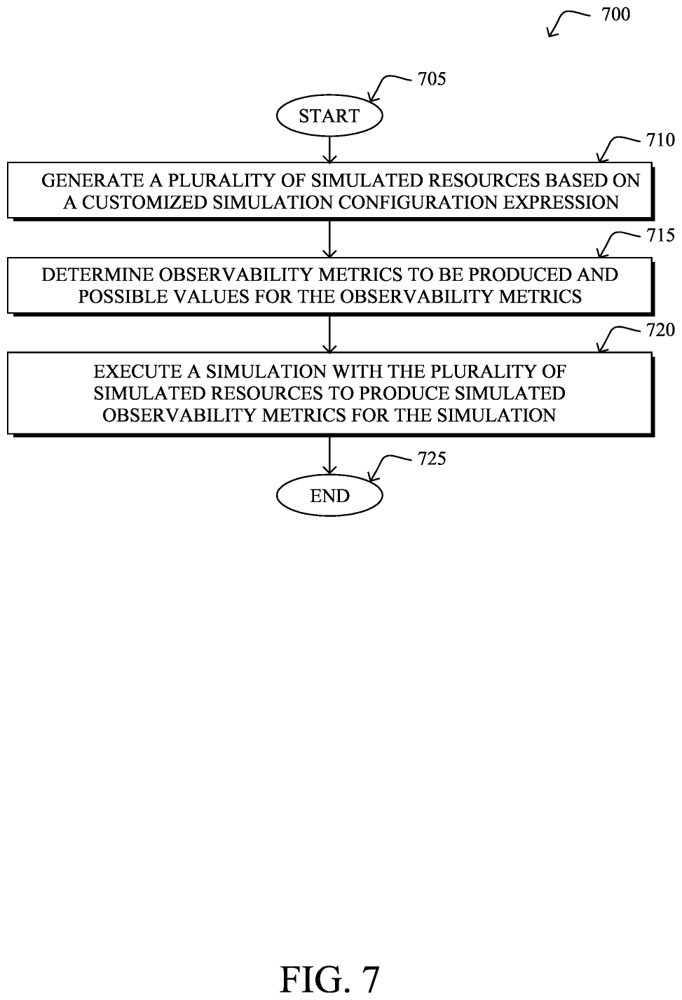

FIG. 7 illustrates an example simplified procedure for state-based observability traffic simulations in accordance with one or more embodiments described herein.

### DESCRIPTION OF EXAMPLE EMBODIMENTS

### Overview

According to one or more embodiments of the disclosure, state-based observability traffic simulations are provided by a method that includes generating a plurality of simulated resources based on a customized simulation configuration expression that defines one or more resource types and a respective number of each of the one or more resource types to generate. The method further includes determining, from the customized simulation configuration expression, observability metrics to be produced in relation to the plurality of simulated resources and a plurality of possible values for the observability metrics and executing a simulation with the plurality of simulated resources to produce simulated observability metrics for the simulation.

Other embodiments are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

FIG. 1 is a schematic block diagram of a simplified example of a computing system 100 that illustratively comprises client devices 102 (e.g., a first through nth client device, any number of client devices), one or more servers 104, and one or more databases 106, where the devices may be in communication with one another via network(s) 110 (e.g., any number of networks). The network(s) 110 may include, as would be appreciated, any number of specialized networking devices such as routers, switches, access points, etc., interconnected via wired and/or wireless connections. For example, the devices and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers and/or databases, including any number of other suitable devices (e.g., firewalls, gateways, and so on) may be part of a cloud-based service. In such cases, the servers and/or databases may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

FIG. 2 is a schematic block diagram of an example node/device 200 that may be used with one or more implementations described herein, e.g., as any of the client devices 102-106 shown in FIG. 1 above. Device 200 may comprise one or more network interfaces 210 (e.g., wired, wireless, etc.), a processor 220 (or processors), and a memory 240 interconnected by a system bus 250, as well as a power supply 260 (e.g., battery, plug-in, etc.).

The one or more network interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via one or more network interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the one or more network interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes 246, and on certain devices, illustratively a traffic simulation process 248, as described herein. Notably, the one or more functional processes 246, when executed by processor 220 (or processors), cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

### —Observability Intelligence Platform—

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more implementations herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents 310 and one or more servers/controllers 320. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 (or controllers) as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface, UI 330 that is the primary interface for monitoring, analyzing, and troubleshooting the monitored environment. Specifically, the controller 320 can receive data from one or more agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the UI 330. The UI 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, an instance of controller 320 may be installed locally and self-administered.

The controller 320 (or controllers) receives data from different agents of the one or more agents 310 (e.g., Agents 1-4) deployed to monitor networks, applications, databases and database servers, servers, and end user clients for the monitored environment. Any of the one or more agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one implementation, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain implementations, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### —State-Based Observability Traffic Simulations—

As noted above, when building or working with platforms built for analyzing application and/or infrastructure (e.g., a computing infrastructure, network infrastructure, etc.) performance, there is an implicit need to test such a platform and demonstrate its capabilities. This need also extends to any solutions or other extensions that are built on top of the platform, as well. Increasingly, these monitoring platforms are using known network metric collection/observability standards, which define the message schema of the messages sent from the observed application and/or infrastructure to the monitoring platform for analysis.

Today, demonstrating the capabilities of the application and/or infrastructure is typically achieved by first deploying dummy infrastructure for observation. Of course, there is an extra resource cost associated with doing this for testing and/or demonstration purposes. In addition, such testing cannot be precisely controlled, and the actual data being sent to the platform is generally not deterministic.

Simulating observability message traffic would open up new opportunities for purposes of testing and demos. However, this is not a simple process, particularly with respect to the experience of third parties building extensions on top of the platform. Indeed, they may be required to perform deeply involved, code-based setup and deployment of the solution. Debugging any input errors can also prove challenging, depending on the implementation.

The techniques herein, therefore, provide for state-based observability traffic simulations, particularly for testing, demonstrating, and/or analyzing application performance and/or infrastructure performance. For example, aspects of the disclosure allow for the simulation of observability messages and testing of online applications and/or infrastructures to show the capabilities of such online applications and/or infrastructures prior to deployment in the real world.

Specifically, according to one or more embodiments described herein, a method for state-based observability traffic simulations includes generating a plurality of simulated resources based on a customized simulation configuration expression that defines one or more resource types and a respective number of each of the one or more resource types to generate. The method further includes determining, from the customized simulation configuration expression, observability metrics to be produced in relation to the plurality of simulated resources and a plurality of possible values for the observability metrics and executing a simulation with the plurality of simulated resources to produce simulated observability metrics for the simulation.

Notably, when observing systems such as online applications, computing infrastructures, and the like, it is useful to view observability metrics, such as metrics, events, logs, and traces (which may be referred to herein a “MELT data”). Logs and events can be similar and may be used interchangeably in some contexts, although with respect to observability platforms logs and events may have a separate categorization.

In general, the metrics, events, logs, and/or traces that are sent as part of an observability platform are used for reporting the state of a current piece of infrastructure. This current piece of infrastructure or, more generally, any piece of infrastructure, may be referred to as a “resource.” When metrics, events, logs, or traces are sent to the observability platform (although it is noted that this is not mandatory by network metric collection/observability protocols), they will almost always have uniquely identifiable information regarding the resource whose observability metrics are being reported.

Given that there are almost infinite possibilities of the types of resources, metrics, events, logs, and traces that real systems may generate, along with the large number of such system components that may be of interest to simulate, it would be beneficial to have a concise way to represent the simulated resources and the observability metrics that could be generated for such real systems. As discussed in more detail herein, this can be done by defining a type (e.g., a resource type, observability metric type, etc.) and then scaling up through the use of expressions (e.g., simulation configuration expressions). For example, consider a resource of type “iPhone 13,” which has uniquely identifiable attributes like an international mobile equipment identity (IMEI), a phone number, and so on. In this example, the “iPhone 13” type can be defined as follows:
name: ‘iPhone 13’
count: ‘100’
IMEI: ‘SrandomDecimals(32)’
Phone number: ‘SrandomDecimals(10)’

Using such definition schemes, any number of resources of a single type can be simulated. Further, because observability metrics are generated for the resources, in most cases observability metrics can therefore be scaled up as the quantity of resources are scaled up.

In some embodiments, as discussed in more detail herein, JavaScript Object Notation (JSON), which, as will be appreciated, is a data interchange format that uses human-readable text to store and transmit data objects consisting of attribute-value pairs and arrays (or other serializable values) may be utilized in connection with observing the systems described herein and/or simulating such systems. Further, JSONata, which is a lightweight, open-source query and transformation language for JSON format documents may also be utilized in connection with observing the systems described herein and/or simulating such systems. The lightweight nature of this language means that it has a very limited set of supported operations; however, this may be advantageous because these characteristics can make learning easier, in addition to the fact that an online JSONata processor is readily available for anyone wanting to test or try their JSON transformations.

In the non-limiting examples shown herein, the simulation specification and/or definition is shown in the JSON format and the expressions to be evaluated dynamically are shown in the JSONata language. It will however be appreciated that embodiments described herein are not limited to utilization of JSON and/or JSONata and other formats, protocols, and/or languages may be employed without departing from the scope of the disclosure.

In order to elucidate various aspects of the disclosure, a non-limiting example follows. In this non-limiting example, Amazon Web Services (AWS) resource and observability metrics are explored by using a simulation configuration expression to generate and collect simulated network traffic metrics. It will be appreciated that aspects of the disclosure are applicable to virtually any application (e.g., online application) and to virtually any system (e.g., computing system, distributed computing architecture, network architecture, etc.) and are not to be taken in a limiting sense. At first, the following representation for an AWS My Structured Query Language (MySQL) database cluster is provided to, for example, a device:
name: mysql_database_cluster
count: 10
attributes:
   database_cluster.host: “${[0 . . . 10].[‘mysql-’ & $ & ‘.cluster-473653744458.us-west-2.rds.amazonaws.com’][0]}”
   database_cluster.port: 3306
   cloud.provider: “AWS”
   cloud.database_cluster.id: “${‘db-mysql-’ & $hexadecimals(32)}”
   database_cluster.name: “${[0 . . . 10].[‘MySQL cluster’ & $]}”

The above pseudo-code specifies ten MySQL database clusters on AWS. Specifying a single value for an attribute will mean that all ten clusters get the same value for that attribute. Wrapping a string with ${ } means that the values are to be generated dynamically. For example, in the case of “database_cluster.host,” the [0 . . . 10], JSONata notation will generate a numeric value starting with zero and incrementing it for each new cluster. This value is then concatenated with some strings in JSONata syntax to obtain realistic values for a MySQL database cluster on AWS.

Next, a representation of the MySQL database instance is generated. This representation may, in this non-limiting example, look something like this:
name: mysql
count: 30
attributes:
   database_instance.host: “${[0 . . . 30].[‘mysql-instance-’ & $ & ‘.cluster-473653744458.us-west-2.rds.amazonaws.com’][0]}”
   database_instance.port: 3306
   cloud.provider: “AWS”
   cloud.database_instance.id: “${‘db-mysql-instance-’ & $hexadecimals(32)}”
   database_instance.name: “${[0 . . . 30].[‘MySQL instance’ & $]}”
   database_instance.cluster_name: “${[0 . . . 30].[‘MySQL cluster’ & $/3]}”

Here, thirty MySQL database instances are specified and most of the attributes are quite similar. However, the last line of the above pseudo-code: “database_instance.cluster_name” represents a one to three (1:3) relationship between the MySQL clusters and corresponding database instances.

Next, an example of simulating two metrics (e.g., observability metrics) for a particular MySQL database instance is shown. It is noted that, in accordance with the disclosure, the example can be scaled to any number of metrics; however, two metrics are shown here for brevity.
name: “aws:database_instance.lvm.read.operations_sec”
resourceSelector: “${$lookup ($.resources, ‘mysql’)}”
type: “summary”
value: “${$random( )*1000}”
unit: “{operations}/s”

For metrics, a name, type, and unit (as per the network metric collection/observability protocols), as well as a target platform schema can be specified, while the resource selector and value can be used to tune the simulation. In some instances, this can be done in accordance with the OTEL standard.

In accordance with one or more embodiments herein, the resource selector should be an expression that evaluates to a list of resources specified in the input JSON along with these metrics. In this example, the resources of type “mysql” are selected, so all thirty MySQL database instances will report this metric. In addition, via JSONata expressions, it is possible to filter this list further based on the evaluated attribute values or even expand the list of resources by appending other resource types to the list.

In general, the value field should specify an expression that evaluates to a number (ideally a different number each time, although embodiments are not so limited). When this program is called to send the metrics to the platform, this expression will be called, and the value obtained in response to the call will be the value of this metric in the observability data or observability metrics (e.g., in observability data, such as MELT data).

Further, embodiments of the disclosure allow for the generation of various metrics, such as observability metrics, based on specific triggers. Continuing with the foregoing non-limiting example, observability data, such as metrics, events, logs, and traces, can be generated using the following pseudo-code (or similar types of pseudo-code and/or other types of code).
name: “aws:database_instance.lvm.write.operations_sec”
resourceSelector: “${$lookup ($.resources, ‘mysql’)}”
type: “summary”
value: “${($.state=‘HIGH_LOAD’? 3:1)*$random( )*1000}”
unit: “{operations}/s”

Moreover, aspects of the present disclosure further allow for the ability to store variables in the “applicationData” field. In these embodiments a variable “state” can be used to represent the state of the load on the system and/or changes to output values based on changes to the variable state. In order to facilitate such embodiments, the JSONata code can be made available for users for configuration to provide the ability to employ customizable logic and/or customizable inputs to control the transitions of any of the variables described herein. In addition, this customizable behavior can allow for insights and/or the ability to alter the variables in scenarios in which another component (e.g., one or more other components in the system) are being changed or altered independently.

Continuing with this non-limiting example, after evaluation of the resources and metrics described above, an output based on the metric collection traffic simulations can be provided. In some embodiments, a user interface, such as the UI 330, can display the output(s). The output may include, among other information, evaluated resources, input metrics, and/or network metric collection packets.

Operationally, FIGS. 4A-4B illustrate an example change in a configuration expression based on a change in a state field in accordance with one or more embodiments described herein. For example, FIGS. 4A-4B illustrate the mechanics involved with the configuration expressions described herein when parameters of the configuration expression are changed. More specifically, the examples shown in FIGS. 4A-4B illustrate how the value for the “aws:database_instance.lvm.write.operations_sec metric” may change based on the “state” field in the inputs of the non-limiting example described above.

FIG. 4A illustrates an example output visualization 400 where the state field is set to “NORMAL.” In this particular example, the output value for the input “aws:database_instance.lvm.write.operations_sec metric” under the “metrics” portion of the example output visualization 400 reads as follows:
“metrics”” [
{
“name”: “ws:database_instance.lvm_write.opertions_sec”,
“aggregationTemporality”: “AGGREGATION_TEMPORALTIY_CUMULATIVE”
“sum”: {
   “datapoints”: [
{
   “starttimTimeUnixNano”: 1686844224276000000,
   “time UnixNano”: 1686844224276000000,
   “asDouble”: 314.9057669391
}
. . .

In contrast, FIG. 4B illustrates an example output visualization 401 where the state field is set to “HIGH_LOAD.” In this particular example, the output value for the input “aws:database_instance.lvm.write.operations_sec metric” under the “metrics” portion of the example output visualization 401 reads as follows:
“metrics”” [
{
“name”: “ws:database_instance.lvm_write.opertions_sec”,
“aggregationTemporality”: “AGGREGATION_TEMPORALTIY_CUMULATIVE”
“sum”: {
   “datapoints”: [
{
   “starttimTimeUnixNano”: 1686844224276000000,
   “time UnixNano”: 1686844224276000000,
   “asDouble”: 2770.627693536
}
. . .

Accordingly, it will be appreciated that changes in the configuration expressions, such as changes to the state field or other fields discussed herein, can alter the values returned in the metrics field or other fields described herein. In this manner, the customizable simulations of the disclosure can produce simulated observability metrics in accordance with the disclosure.

FIG. 5 illustrates an example platform 500 for state-based observability traffic simulations in accordance with one or more embodiments described herein. The example platform 500 can perform the operations described herein, such as the operations described above in the non-limiting pseudo-code example(s) and/or the operations described below in connection the remaining Figures.

As shown in FIG. 5, the example platform 500 includes a full stack observability platform 520 (i.e., the “FSO platform”), which can include an observability ingestion endpoint 522 (e.g., an OTEL ingestion point). As shown in FIG. 5, the full stack observability platform 520 can generate a simulator solution 526 (e.g., an executed simulation with a plurality of simulated resources that produces simulated observability metrics for the simulation). The simulator solution 526 can be generated by the full stack observability platform 520 in connection with information written to and retrievable by the full stack observability platform 520 and/or the simulator solution 526 from a state store 528.

The state store 528 can be a portion of a memory resource associated with the example platform 500 that is configured to store data as variables that can represent storage locations in the memory resource. Accordingly, the state store 528 can be used to maintain the current state of the computation, e.g., states of the operations described herein, as well as data (e.g., observability data collected at various points in time), thereby allowing application to efficiently process incoming events in real time.

In some embodiments, a user can define various parameters of the operations described herein and execute the same as a cronjob. It will be appreciated that a “cronjob” generally refers to operations that are run periodically at fixed times, dates, or intervals, and can be accessed via a command-line utility that calls a handler, job scheduler or similar utility and can be implemented in response to a cronjob trigger 524. For simplicity, the scheduling of such operations to as a “cronjob,” but it will be appreciated that other job scheduling utilities could also be used without departing from the scope of the disclosure. It will further be appreciated that the cronjob trigger 524 can allow a user to map a cron expression to a handler, job scheduler, or the like in order to facilitate scheduling of the various operations described herein.

In some embodiments, the example platform 500 can be accessed by a Javascript server application that can interact with the example platform 500 to provide state-based observability traffic simulations. For example, a user of the server application and/or example platform 500 can define their own input specifications and therefore modify the JSONata code (or other code to perform the operations described herein) as necessary.

As shown in FIG. 5, these user-based modifications may be triggered as a cronjob (e.g., in connection with the cronjob trigger 524) thereby allowing users the ability to define how frequently the JSONata is evaluated and/or the observability data is posted to the observability ingestion endpoint 522 of the example platform 500. Therefore, instead of merely providing a standalone tool, embodiments of the disclosure may leverage an understanding of the example platform 500 to simplify operation for testers, third party extension developers, DevOps, etc. to conduct observability traffic simulations in order to simulate observability data in the systems described herein.

In some embodiments, when the example platform 500 invokes a solution (e.g., when the operations described herein are executed) the current state from the state store 528 is retrieved. In such embodiments, the state store 528 can store the input JSON instructions described herein as well as the JSONata code described herein. This information can be provided to the example platform 500 where it can be evaluated by, for example, the full stack observability platform 520, the simulator solution 526, and/or the standalone application discussed above to provide an output that includes the specification as well as observability data. In some embodiments, the output can be split or otherwise organized to provide a solution, such as the simulator solution 526. At this point, previously stored specification information can be overwritten into the state store 528 as the current state while the observability data is posted to the example platform 500.

FIG. 6 illustrates an example state diagram 600 for state-based observability traffic simulations in accordance with one or more embodiments described herein. As shown in FIG. 6, a user 630 can update a state of a simulation (e.g., a state of the simulator solution 526 of FIG. 5) to trigger a state transition. In this example, information associated with the state transition can be provided to a state store 628 (which can be analogous to the state store 528 of FIG. 5).

As shown at operation (1) in FIG. 6, the simulator solution 626, which can be analogous to the simulator solution 526 of FIG. 5, can read a state of the simulation from the state store 628. The simulator solution 626 can include multiple simulated resources based on a customized simulation configuration expression that defines one or more resource types and/or a respective number of each of the one or more resource types that are generated and associated with the simulator solution. The simulator solution 626 can update the simulation state as indicated at (2). The simulator solution 626 can, at (3), write the simulation state back to the state store 628. In addition, as shown at (4), the simulator solution 626 can push observability metrics (e.g., observability metrics that are produced during execution of the simulation) to an observability ingestion endpoint 622, which may be analogous to the observability ingestion endpoint 522 of FIG. 5.

Further, as shown in FIG. 6, a cronjob trigger 624, which can be analogous to the cronjob trigger 524 of FIG. 5, can be utilized to provide timing of various events involving the processes and/or components shown in the example state diagram 600. As discussed herein, the cronjob trigger 624 can facilitate execution of the simulation periodically in response to various user inputs. For example, the cronjob trigger 624 may operate in response to a set of user defined parameters that can be chosen from a group consisting of: a frequency of execution of the simulation and a frequency of reporting the simulated observability metrics for the simulation, among other parameters.

Accordingly, the cronjob trigger 624 can automatically execute and/or continuously re-execute the simulation periodically based on various parameters controlled by the user 630 in response to command (e.g., a cron command), such as a frequency of data collection, a frequency of data reporting, a frequency of state change reporting, etc. As discussed above, embodiments are not so limited, and commands other than a cron command that allow for periodic execution of the various operations described herein are contemplated within the scope of the disclosure.

Stated alternatively, a user 630 (or other entity or persona) can request that a state of the simulation (e.g., a simulation involving multiple simulated resources to produce simulated observability metrics for the simulation) is updated. This action may trigger a state transition (e.g., a state change or state changes) that is then stored by the state store 628. The simulator solution 626 receives the state changes at (1) and, according to information provided to the cronjob trigger 624, updates the simulation state (2) and/or writes the simulation state (3) to the state store 628. At periodic intervals controlled by the cronjob trigger 624 and inputs thereto, the simulator solution 626 causes observability metrics to be “pushed” (4) or otherwise written to or committed to the observability ingestion endpoint 622. As discussed above in connection with FIG. 5, the observability ingestion endpoint can be associated with a full stack observability platform 520.

In closing, FIG. 7 illustrates an example simplified procedure for state-based observability traffic simulations in accordance with one or more embodiments described herein, particularly from the perspective of either an edge device or a controller. For example, a non-generic, specifically configured device (e.g., device 200) may perform procedure 700 by executing stored instructions (e.g., traffic simulation process 248, such as a monitoring process). In some embodiments, the procedure (e.g., a method) may be performed using a tangible, non-transitory, computer-readable medium having computer-executable instructions stored thereon that, when executed by a processor on a computer, cause the computer to perform the procedure 700 (e.g., a method).

The procedure 700 may start at step 705, and continues to step 710, where, as described in greater detail above, a plurality of simulated resources based on a customized simulation configuration expression that defines one or more resource types and a respective number of each of the one or more resource types to generate are generated.

In some embodiments, the customized simulation configuration expression can define a configuration for sets of the one or more resource types concurrently. For example, if there are two resource types (“Type A” and “Type B”), the customized simulation configuration expression can configure both resource Type A and resource Type B at the same time. In addition to, or in the alternative, the customized simulation configuration expression can define an identification (e.g., an ID number) for each of resource Type A and resource Type B at the same time.

At step 715, as detailed above, observability metrics to be produced in relation to the plurality of simulated resources and a plurality of possible values for the observability metrics are determined from the customized simulation configuration expression. As discussed above, the observability metrics can include metrics, events, logs, and traces (e.g., MELT data), among other observability metrics.

At step 720, as detailed above, a simulation is executed with the plurality of simulated resources to produce simulated observability metrics for the simulation (e.g., a simulator solution). In some embodiments, a current state and/or a current set of the observability metrics can be stored (e.g., in a data store) and/or reported (e.g., to a user) in response to executing the simulation.

As discussed above, the simulation may be executed periodically. For example, the simulation may be executed periodically in response to a cron trigger, as described in connection with FIG. 5 and FIG. 6, above. Accordingly, the simulation can be executed periodically based on a set of user defined parameters chosen from a group consisting of: a frequency of execution of the simulation and a frequency of reporting the simulated observability metrics for the simulation, among other possible parameters.

In some embodiments, state changes associated with the plurality of simulated resources can be determined from the customized simulation configuration expression. In addition, resource performance metrics responsive to the state changes associated with the plurality of simulated resources can be determined. The simulation can then be executed using the state changes associated with the plurality of simulated resources. The state changes can correspond to various events, such as a time of day, occurrence of an event, a user-initiated request to change one or more states, etc.

In such embodiments, the resource performance metrics may change based on the state changes. For example, different ranges of numbers may be determined for the simulated resources based on daytime usage vs. nighttime usage of a resource, a determination that more or fewer requests are being transferred by or to the resource, load states of the resource, etc. These changing resource performance metrics may be monitored and/or reported in order to provide insights into the behavior of the simulated resources, as well as to provide a holistic view of the simulation.

In some embodiments, one or more simulated identifiable attributes for each of the one or more resource types may be defined based on the customized simulation configuration expression. In such embodiments, the one or more simulated identifiable attributes can have respective values associated therewith. These respective values can include numbers (e.g., Arabic numerals) and/or strings (e.g., bit strings, combinations of numbers and letters, etc.).

As discussed above, one or more simulated identifiable attributes for each of the one or more resource types can be defined based on the customized simulation configuration expression. In such embodiments, the one or more simulated identifiable attributes can be formatted to appear as real identifiable attributes. For example, if, as in the non-limiting example given above, one or more iPhones are being monitored, the simulated identifiable attributes (e.g., the IMEIs, phone numbers, device names, etc.) for the iPhones should appear as corresponding real attributes for the iPhones would appear. That is, if a real phone number attribute for a particular iPhone contains ten Arabic numerals, the simulated identifiable phone number attribute for a particular simulated iPhone should also contain ten Arabic numerals. Similarly, if an IMEI attribute for a particular iPhone contains a given quantity of numbers, the simulated identifiable phone number attribute for a particular simulated iPhone should also contain the same given quantity of numbers, etc.

In some embodiments, a same value may be assigned to all of the one or more simulated identifiable attributes having a particular attribute. For example, continuing with the non-limiting example above, when there are multiple iPhones, a value of “iPhone” may be assigned to each of the simulated iPhones.

In some embodiments, a dynamic portion of the one or more simulated identifiable attributes can be concatenated with a static portion of the one or more simulated identifiable attributes within a particular attribute among the one or more simulated identifiable attributes. For example, if a particular simulated identifiable attribute is “12345ABC,” where “12345” is the static portion and “ABC” is the dynamic portion, the simulated identifiable attribute could be altered (in response to a state change, for example) to “12345XYZ,” etc.

In some embodiments, random values at defined lengths may be generated as part of defining the one or more simulated identifiable attributes. For example, if the simulated resource includes a media access control (MAC) address, a random value having the same length and general appearance as an actual MAC address may generated and provided as one or more of the simulated identifiable attributes.

The plurality of simulated resources can, in some embodiments, be filtered to generate a plurality of filtered simulated resources. For example, the plurality of simulated resources may be filtered such that data (e.g., observability metrics, etc.) are only reported when above a certain value, or data may only be reported from devices with particular attributes (e.g., identification, names, simulated identifiable attribute, etc.), among other possible filtering schemes. In such embodiments, observability metrics corresponding to the plurality of filtered simulated resources (as opposed to all the simulated resources) may be reported.

As discussed above, the simulation may be specified in a JavaScript Object Notation (JSON) format, although embodiments are not so limited. In embodiments in which the simulation is specified in the JSON format, the customized simulation configuration expression is specified in a query and translation language (e.g., the JSONata format) for the JSON format.

The procedure 700 may then end in step 725.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for state-based observability traffic simulations. In particular, the techniques herein provide for state-based observability traffic simulations, particularly for testing, demonstrating, and/or analyzing application performance and/or infrastructure performance. For example, aspects of the disclosure allow for the simulation of observability messages and testing of online applications and/or infrastructures to show the capabilities of such online applications and/or infrastructures prior to deployment in the real world.

However, current simulators typically rely on the random generation of observability data. In addition, current simulators generally require deployment of dummy infrastructure for observation, which carries an extra resource cost associated therewith for testing and/or demonstration purposes. Further, such testing cannot be precisely controlled, and the actual data being sent to the platform is generally not deterministic. Moreover, such current approaches are typically standalone solutions, meaning that for testing or demonstrating the capabilities of the platform (or 3rd party extensions built on the platform), the users would first have to understand these tools and how they might interoperate with the platform.

In contrast, embodiments described herein generally do not require deployment of dummy infrastructure for observation and are designed to be controlled with high precision. Further, embodiments herein are deterministic, thereby alleviating issues associated with non-deterministic approaches. Moreover, the embodiments herein do not require that users have a specialized understanding of infrastructure observability tools and how the same interoperate with the platform.

In still further embodiments of the techniques herein, a business impact of the results of the state-based observability traffic simulations can also be quantified. That is, because of issues related to specific applications and/or processes (e.g., lost traffic, slower servers, overloaded network links, etc.), various corresponding business transactions may have been correspondingly affected for those applications and/or processes (e.g., online purchases were delayed, page visits were halted before fully loading, user satisfaction or dwell time decreased, etc.), while other processes (e.g., on other network segments or at other times) remain unaffected. The techniques herein, therefore, can correlate the results of the state-based observability traffic simulations with various business transactions in order to better understand the effect on the business transactions, accordingly.

Illustratively, the techniques described herein may be performed by hardware, software, and/or firmware, such as illustratively in accordance with the traffic simulation process 248, which may include computer executable instructions executed by the processor 220 to perform functions relating to the techniques described herein, e.g., in conjunction with corresponding processes of other devices in the computer network as described herein (e.g., on network agents, controllers, computing devices, servers, etc.). In addition, the components herein may be implemented on a singular device or in a distributed manner, in which case the combination of executing devices can be viewed as their own singular “device” for purposes of executing the traffic simulation process 248.

While there have been shown and described illustrative embodiments above, it is to be understood that various other adaptations and modifications may be made within the scope of the embodiments herein. For example, while certain embodiments are described herein with respect to certain types of networks in particular, the techniques are not limited as such and may be used with any computer network, generally, in other embodiments. Moreover, while specific technologies, protocols, and associated devices have been shown, such as Java, TCP, IP, and so on, other suitable technologies, protocols, and associated devices may be used in accordance with the techniques described above. In addition, while certain devices are shown, and with certain functionality being performed on certain devices, other suitable devices and process locations may be used, accordingly. That is, the embodiments have been shown and described herein with relation to specific network configurations (orientations, topologies, protocols, terminology, processing locations, etc.). However, the embodiments in their broader sense are not as limited, and may, in fact, be used with other types of networks, protocols, and configurations.

Moreover, while the present disclosure contains many other specifics, these should not be construed as limitations on the scope of any embodiment or of what may be claimed, but rather as descriptions of features that may be specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
generating a plurality of simulated resources based on a customized simulation configuration expression that defines one or more resource types and a respective number of each of the one or more resource types to generate;
determining, from the customized simulation configuration expression, observability metrics to be produced in relation to the plurality of simulated resources and a plurality of possible values for the observability metrics; and
executing a simulation with the plurality of simulated resources to produce simulated observability metrics for the simulation.

2. The method as in claim 1, further comprising:
determining, from the customized simulation configuration expression, state changes associated with the plurality of simulated resources;
determining resource performance metrics responsive to the state changes associated with the plurality of simulated resources; and
executing the simulation using the state changes associated with the plurality of simulated resources.

3. The method as in claim 2, wherein the resource performance metrics change based on the state changes.

4. The method as in claim 1, wherein the observability metrics comprise metrics, events, logs, and traces.

5. The method as in claim 1, further comprising:
defining one or more simulated identifiable attributes for each of the one or more resource types based on the customized simulation configuration expression, wherein the one or more simulated identifiable attributes are formatted to appear as real identifiable attributes.

6. The method as in claim 5, further comprising:
assigning a same value to all of the one or more simulated identifiable attributes having a particular attribute.

7. The method as in claim 5, further comprising:
concatenating a dynamic portion of the one or more simulated identifiable attributes with a static portion of the one or more simulated identifiable attributes within a particular attribute among the one or more simulated identifiable attributes.

8. The method as in claim 5, further comprising:
randomly generating values at defined lengths as part of defining the one or more simulated identifiable attributes.

9. The method as in claim 1, wherein the customized simulation configuration expression defines a configuration for sets of the one or more resource types concurrently.

10. The method as in claim 1, further comprising:
defining one or more simulated identifiable attributes for each of the one or more resource types based on the customized simulation configuration expression, wherein:
the one or more simulated identifiable attributes have respective values associated therewith, and
the respective values comprise numbers or strings, or both.

11. The method as in claim 1, further comprising:
executing the simulation periodically in response to a cron trigger.

12. The method as in claim 11, further comprising:
executing the simulation periodically based on a set of user defined parameters chosen from a group consisting of: a frequency of execution of the simulation and a frequency of reporting the simulated observability metrics for the simulation.

13. The method as in claim 1, wherein the observability metrics are reported via OTEL packets.

14. The method as in claim 1, further comprising:
filtering the plurality of simulated resources to generate a plurality of filtered simulated resources; and
reporting observability metrics corresponding to the plurality of filtered simulated resources.

15. The method as in claim 1, wherein:
the simulation is specified in a JavaScript Object Notation format, and
the customized simulation configuration expression is specified in a query and translation language for the JavaScript Object Notation format.

16. A tangible, non-transitory, computer-readable medium having computer-executable instructions stored thereon that, when executed by a processor on a computer, cause the computer to perform a method comprising:
generating a plurality of simulated resources based on a customized simulation configuration expression that defines one or more resource types and a respective number of each of the one or more resource types to generate;
determining, from the customized simulation configuration expression, observability metrics to be produced in relation to the plurality of simulated resources and a plurality of possible values for the observability metrics; and
executing a simulation with the plurality of simulated resources to produce simulated observability metrics for the simulation.

17. The tangible, non-transitory, computer-readable medium as in claim 16, wherein the method further comprises:
determining, from the customized simulation configuration expression, state changes associated with the plurality of simulated resources;
determining resource performance metrics responsive to the state changes associated with the plurality of simulated resources; and
executing the simulation using the state changes associated with the plurality of simulated resources.

18. The tangible, non-transitory, computer-readable medium as in claim 17, wherein the resource performance metrics change based on the state changes.

19. The tangible, non-transitory, computer-readable medium as in claim 16, wherein the method further comprises:
defining simulated identifiable attributes for each of the one or more resource types based on the customized simulation configuration expression, wherein the simulated identifiable attributes are formatted to appear as real identifiable attributes.

20. An apparatus, comprising:
one or more network interfaces to communicate with a network;
a processor coupled to the one or more network interfaces and configured to execute one or more processes; and
a memory configured to store a process that is executable by the processor, the process, when executed, configured to:
generate a plurality of simulated resources based on a customized simulation configuration expression that defines one or more resource types and a respective number of each of the one or more resource types to generate;
determine, from the customized simulation configuration expression, observability metrics to be produced in relation to the plurality of simulated resources and a plurality of possible values for the observability metrics; and
execute a simulation with the plurality of simulated resources to produce simulated observability metrics for the simulation.
